(19) United States
(12) Patent Application Publication
(10) Pub. No.: US 2006/0153487 A1
(43) Pub. Date: Jul. 13, 2006

(54) System and method for packaging a fibre optic sensor

(76) Inventors: John McLellan, Southampton (GB); Maxwell R. Hadley, Lyndhurst, Hampshire (GB); Yuehua Chen, Reading, Berkshire (GB)

Correspondence Address: Schlumberger Technology Corporation;Schlumberger Reservoir Completions, Intellectual Property Counsel, P O Box 1590, Rosharon, TX, 77583-1590, US

(21) Appl. No.: 10/514,871

(22) PCT Filed: May 13, 2003
(86) PCT No.: PCT/GB03/02063

§ 371 Date: Nov. 15, 2004

(30) Foreign Application Priority Data
May 17, 2002 (GB) 0211391.8

(51) Int. Cl. G02B 6/00

(52) U.S. Cl. 385/12; 385/100

(57) ABSTRACT

A fibre optic sensor deployed on a fibre optic cable to a remote location, such as an oil or gas well. The sensor, which can sense any of a variety of parameters such as pressure, temperature, flow rate, strain, or chemical properties, is located within a sleeve. The sleeve is constructed from a low-friction material, such as polytetrafluoroethylene, glass, or ceramic. Further, the sensor can float on a high-density fluid that surrounds it, or sink in a low-density fluid that surrounds it.

### BACKGROUND

This application relates generally to fibre optic sensors. Specifically, this application relates to the deployment and packaging of fibre optic sensors in harsh environments, such as an oil or gas well.

Fibre optic cables and sensors are fragile and sensitive components. Outside forces or elements can easily act on such components in an unwanted manner to, for instance, damage them or decrease their reliability and accuracy. For instance, an external force that bends a fibre optic cable can break the cable. Or, an external force that acts on a fibre optic sensor can reduce the reliability and accuracy of the sensor. Furthermore, fluids and chemicals can interact with the fibre optic cables and sensors to also reduce their reliability and accuracy.

This concern is heightened when the fibre optic cable and sensor is deployed in a harsh environment, such as an oil and gas well. The environment in an oil and gas well often includes extremely high pressures and temperatures as well as a mixture of chemicals, fluids, and solids (such as sands), including fluids and chemicals in different phases.

It is important to protect such fibre optic cables and sensors from outside forces and elements to ensure the functionality, reliability, and accuracy of such components. This is specially true in harsh environments, such as an oil or gas well.

Thus, there exists a need for an arrangement and/or technique that addresses one or more of the problems that are stated above.

### SUMMARY

In one aspect, the invention provides an apparatus for deployment of a sensor, comprising: a fibre optic sensor deployed in a remote location; and the fibre optic sensor housed within a sleeve including a low friction material.

The invention further provides that the sleeve can be constructed from polytetrafluoroethylene.

The invention further provides that the sleeve can be constructed from glass.

The invention further provides that fluid can surround the sensor.

The invention further provides that the fluid can be a high-density fluid.

The invention further provides that the sensor can float in the high-density fluid.

The invention further provides that the fluid can be a low-density fluid.

The invention further provides that the sensor can sink in the low-density fluid.

The invention further provides that a bellows can surround the sensor; a fluid can be disposed within the bellows; the sensor can be adapted to measure a parameter external to the bellows; and the fluid and bellows can transfer the parameter to the sensor.

The invention further provides that the parameter can be pressure and the fluid can transfer the pressure to the sensor as the bellows contracts and expands.

The invention further provides that the parameter can be temperature and the fluid and the bellows can thermally transfer the temperature to the sensor.

The invention further provides that the remote location can be within an oil or gas well.

The invention further provides that the sensor can be deployed to sense an exterior wellbore parameter.

The invention further provides that the sensor can be deployed on a tubing having an interior to sense a parameter in the tubing interior.

The invention further provides that the tubing can comprise a mandrel with a port; the sensor can be installed in the port; and the port can be in fluid communication with an interior of the mandrel.

The invention further provides that the sleeve can be deployed within a package; the fibre optic cable can be deployed within a control line; and the package can be attached to the control line.

The invention further provides that the package and the control line can be connected so as to prevent pressure or fluids from passing from the sensor up through the control line.

The invention further provides that the sleeve can be disposed within and can be attached to a protector; and the protector can be fixed in relation to the control line.

The invention further provides that the sleeve can fixed to the protector.

The invention further provides that a fibre optic cable can be connected to the sensor and can be housed within a tube; the tube can be housed within the control line; the tube can terminate at a location distal to the package; and the tube can protrude into the package.

The invention further provides that the tube can extend within the protector; and the fibre optic cable can extend from the tube to the sleeve.

The invention further provides that a seal can prevent pressure or fluids from passing from the sensor around the exterior of the tube; and a seal can prevent pressure or fluids from passing from the sensor through an interior of the tube.

The invention further provides that the protector can be attached to the tube.

The invention further provides that the protector can include a vent hole providing fluid communication between the interior and exterior of the protector.

The invention further provides that the control line can be U-shaped.

The invention further provides a plurality of fibre optic sensors; that the fibre optic sensors can be deployed in a remote location; and that each fibre optic sensor can be housed within a sleeve including a low friction material.

The invention further provides that each of the fibre optic sensors can be connected to one fibre optic cable.

The invention further provides that each of the fibre optic sensors can be connected to a separate fibre optic cable.

The invention further provides that the sleeve can be constructed from ceramic.

In a second aspect, the present invention provides a method for deploying a sensor, comprising: deploying a fibre optic sensor to a remote location; and providing a sleeve including a low friction material around the sensor.

The invention further provides floating the sensor in a high-density fluid that surrounds the sensor.

The invention further provides deploying the sensor and cable in an oil or gas well.

The invention further provides constructing the sleeve at least partially from polytetrafluoroethylene.

The invention further provides constructing the sleeve at least partially from glass.

The invention further provides constructing the sleeve at least partially from ceramic.

The invention provides surrounding the sensor with a bellows that includes a fluid; measuring a parameter external to the bellows with the sensor; and transferring the parameter from an exterior of the bellows to the sensor through the fluid and the bellows.

The invention further provides that the parameter can be pressure and that the fluid can transfer the pressure to the sensor as the bellows contracts and expands.

The invention further provides the parameter can be temperature and the fluid and bellows can thermally transfer the temperature to the sensor.

In a third aspect, the present invention provides a method for deploying a sensor, comprising: deploying a fibre optic sensor in a remote location; and floating the sensor in a high density fluid that surrounds the sensor.

In a fourth aspect, the present invention provides a method for deploying a sensor, comprising: deploying a fibre optic sensor in a remote location; and sinking the sensor in a low density fluid that surrounds the sensor.

### BRIEF DESCRIPTION OF THE DRAWINGS

FIG. 1 is a schematic of a wellbore with a fibre optic cable and sensor deployed therein.

FIG. 2 is a schematic of a sensor deployed on a tubing.

FIG. 3 is a schematic of a sensor deployed on a ported mandrel.

FIG. 4 is a cross-sectional view taken along line 4-4 of FIG. 3.

FIG. 5 is a schematic of one configuration for sensor deployment.

FIG. 6 is a schematic of another configuration for sensor deployment

FIG. 7 is a schematic showing the attachment of the package that houses a sensor to the control line through with the fibre cable is deployed.

FIG. 8 is a cross-sectional view of the package which houses a sensor

FIG. 9 is a cross-sectional view taken along line 9-9 of FIG. 8.

### DETAILED DESCRIPTION

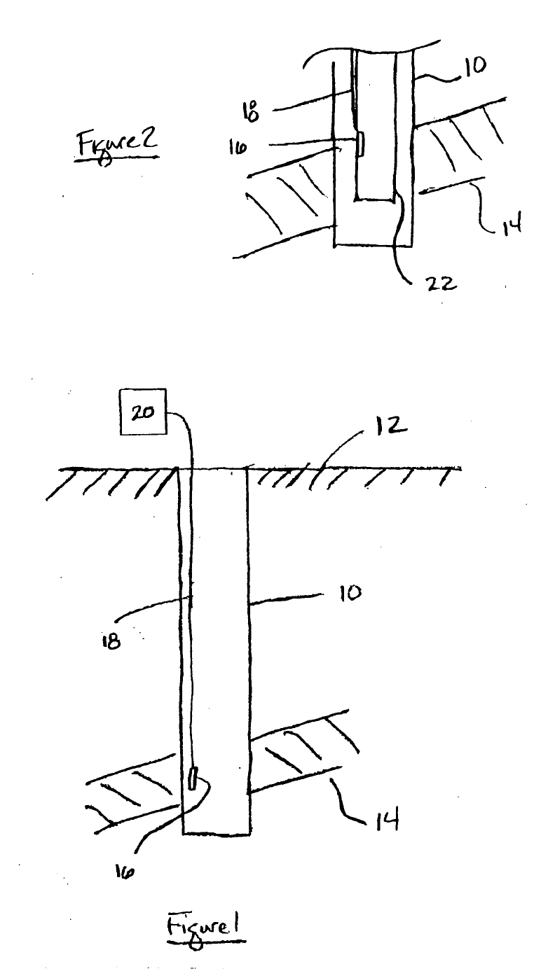

FIG. 1 shows an oil or gas wellbore 10 that extends from the surface 12 (earth or ocean surface) therebelow. The wellbore 10 can intersect at least one hydrocarbon formation 14. When the wellbore 10 is in production, hydrocarbons flow from the formation 14 into the wellbore 10 and to the surface 12, typically by use of equipment (not shown) such as tubing, packers, pumps, flow control equipment, and sand control equipment (“production equipment”). The production equipment is utilized in various configurations depending on the choices of the operator and the wellbore characteristics.

It is often necessary or beneficial to obtain data from the wellbore 10, such as but not limited to pressure, temperature, flow rate, strain, and chemical property measurements. These measurements may be obtained at different stages of the life of a well or throughout the life of a well by deploying sensors in the wellbore. These sensors can be fibre optic sensors, such as the fibre optic sensor 16 deployed on fibre optic cable 18, as shown in FIG. 1. Fibre optic cable 18 is connected to surface equipment 20, which can comprise a light source as well as an acquisition system. Very generally and as is known in the art, the light source propagates a light wave into the fibre optic cable 18, which transmits it to a downhole location to the fibre optic sensor 16. The fibre optic sensor 16 is configured to sense a parameter of the wellbore 10, such as but not limited to pressure, temperature, flow rate, strain, and chemical property, which parameter somehow acts to alter the light wave that is reflected back up the fibre optic cable 18 by the sensor 16 to the surface equipment 20. A relationship exists between the measurand and the degree of light alteration caused by the measurand such that surface equipment 20 then receives the altered reflected light and from it calculates the measurand.

It is understood that sensor 16 may be permanently deployed in the wellbore 10 throughout a substantial portion of the life of wellbore 10 (“permanent sensors”) or it may be used intermittently to obtain measurements at different times in the life of wellbore 10, such as when the wellbore is being tested or drilled or when an intervention is being conducted. In addition, it is understood that sensor 16 can be any of a wide range of fibre optic sensors, such as temperature, pressure, flow rate, strain, or chemical sensors and can comprise any type of optical sensor including interferometric and intensity based sensors.

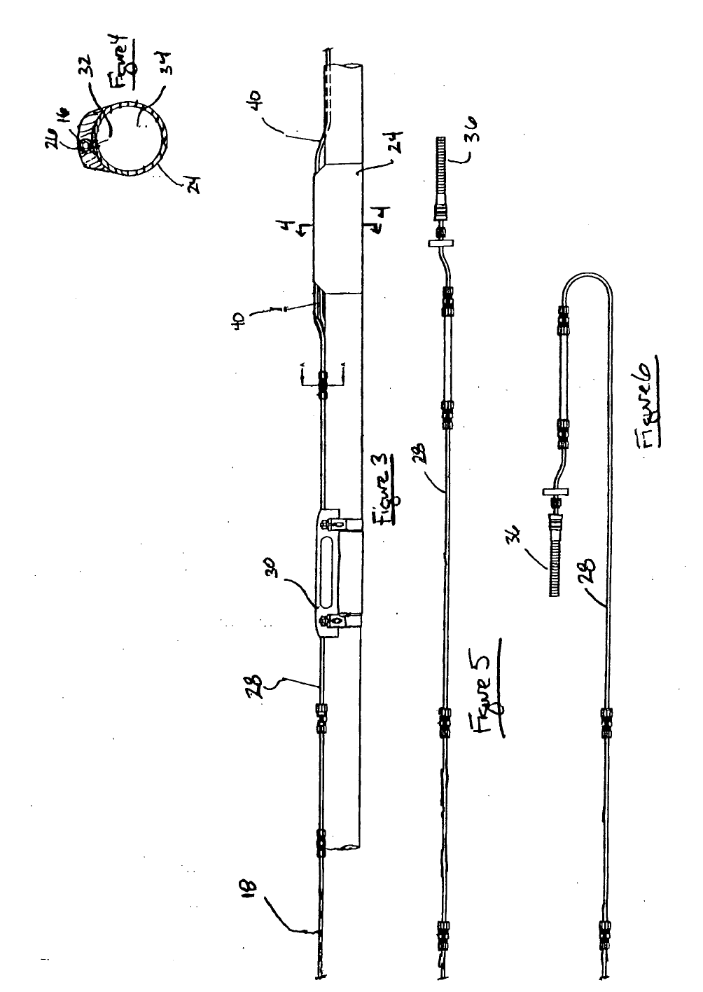

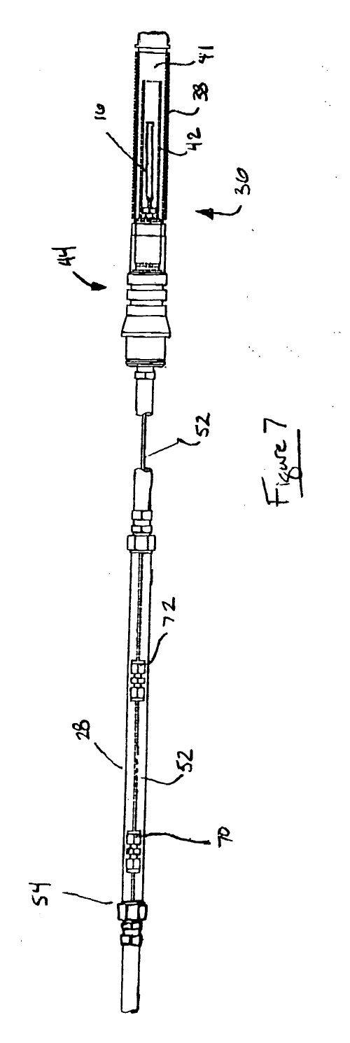

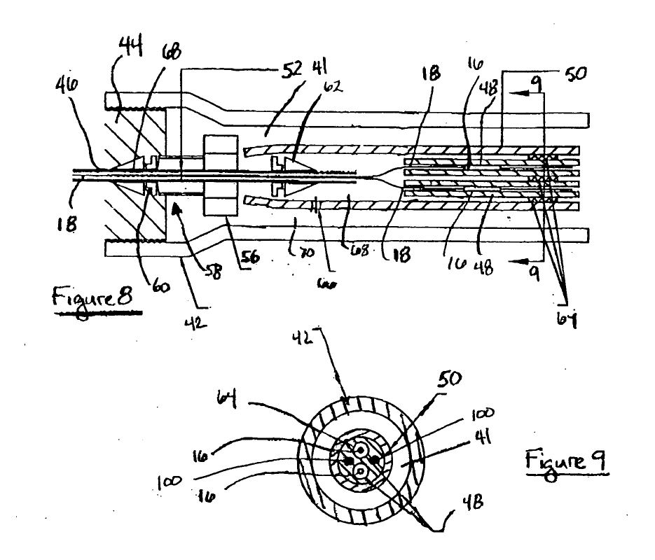

As shown in FIG. 1, sensor 16 measures a parameter in the external wellbore environment (even if production equipment is deployed in wellbore 10). However, as shown in FIG. 2, sensor 16 can also be deployed to measure a parameter in the interior of a tubing 22. Tubing 22 can be production tubing, or any other type of tubing (including coiled tubing), tool, or pipe (including drill pipe), used during the life of wellbore 10. Sensor 16, thus, can be installed within tubing 22 to sense a tubing internal parameter. If deployed on a tubing 22, sensor 16 may be deployed as shown in FIGS. 3 and 4. FIG. 3 shows sensor 16 deployed within the port 26 of a ported mandrel 24. In one embodiment, the fibre optic cable 18 (shown partially in phantom lines in FIG. 3) may be deployed within a control line 28 that protects the fibre optic cable 18. The control line 28 may be attached to the tubing 22 or ported mandrel 24, such as by clamps 30. If the sensor 16 is measuring a parameter within the interior of the ported mandrel 24 or tubing 22, then, as seen in FIG. 4, the ported mandrel 24 may include a passage 32 between the port 26 and the mandrel bore 34 to provide communication therebetween and allow the sensor 16 to measure the relevant parameter in the tubing bore 34 or interior. In one embodiment, ported mandrel 24 is a side-hole mandrel.

Additional control lines 40, including fibre optic cables and sensors, may be deployed together with sensor 16. These additional control lines 40, which may include fibre optic cables and sensors, may be used to measure additional parameters in the wellbore 10 or tubing 22 or may be used to compensate (such as temperature compensation in a pressure measurement) the parameter measured by sensor 16.

The sensor 16 itself may be deployed within a package 36, as shown in FIGS. 5 and 6. Package 36 may be attached to control line 28. Package 36 protects sensor 16 from the harsh environment of wellbore 10, while enabling sensor 16 to measure the relevant parameter. In the embodiment in which sensor 16 is installed in the port 26 of a ported mandrel 24, package 36 is installed within the port 26.

FIGS. 5 and 6 illustrate two ways in which to install the sensor 16 and package 36 within port 26. As shown in FIG. 5, control line 28 feeds the package 36 directly into the mandrel end that is proximate the surface 22. On the other hand, as shown in FIG. 6, control line 28 is configured in a U-shape so that package 36 is installed into the mandrel end that is distal the surface 22 (thus the package 36 is “inverted”). Mandrel 24 can be easily constructed or positioned (such as by flipping it upside down) to function with either method of installation.

FIG. 7 shows a closer view of the attachment between the package 36 and control line 28. As shown, fibre optic line 18 is deployed within control line 28. FIG. 7 shows a specific type of package 36 that may be used with a sensor 16 that measures pressure. In this embodiment, package 36 comprises a bellows 38 that surrounds sensor 16. As pressure fluctuates on the exterior of bellows 38, bellows 38 expands and contracts accordingly. A fluid 41 is located within bellows 38 and surrounds sensor 16. The fluid 41 transfers the pressure change caused by the expansion and contraction of bellows 38 to the sensor 16. The sensor 16 is thus able to measure the external pressure. Bellows 38 may be constructed from a flexible metal, such as inconel, that can withstand the temperatures, pressures, chemical environment, and elements found in a wellbore 10.

The package 36 of FIG. 7 may also be used with a sensor 16 that measures temperature. In this case, the temperature of the exterior of the bellows 38 is transferred through the bellows 38 and fluid 41 to the temperature sensor 16.

FIGS. 8 and 9 further illustrate package 36 and a way in which sensor 16 can be housed within package 36. Although these figures show two sensors 16, each attached to its own fibre optic cable 18, deployed within package 36, it is understood that one or any number of sensors 16 may be housed therein. Furthermore, any number of sensors 16 may be functionally connected to one fibre optic cable 18.

Package 36 may comprise a housing 42 that surrounds the sensor 16. Housing 42, which may be constructed from stainless steel, may be attached such as by attachment section 44 to the control line 28. Attachment section 44 may be constructed from several parts, and includes a hole 46 therethrough to allow passage of fibre optic cable 18. In the embodiment in which package 36 includes a bellows 38, housing 42 may be located within the bellows 38, and the bellows 38 may also be attached to the attachment section 44.

Fibre optic cable 18 may end in sensor 16. In one embodiment, sensor 16 is deployed within a sleeve 48, which may be located within a protector 50. Sensor 16 will sometimes sway, such as for instance if the wellbore 10 is inclined or angled or if it is subject to vibration, which may cause sensor 16 to contact sleeve 48, the protector 50 (if sleeve 48 is not present), or the housing 42 (if neither sleeve 48 nor protector 50 are present). When sensor 16 contacts either sleeve 48, protector 50, or housing 42, the friction caused by such interaction may cause sensor 16 to take erroneous readings. In order to prevent such erroneous readings, in one embodiment, sleeve 48 is constructed from a low friction material. Moreover, it is also advantageous for such sleeve 48 to be constructed from a material that is chemically unreactive with the fluid 41 that is within package 36. Thus, if and when sensor 16 contacts sleeve 48, the interaction does not add to the external forces acting on sensor 16 thereby allowing sensor 16 to take the true reading of the relevant parameter, such as pressure. And, the interaction between the fluid 41 and the chemically unreactive sleeve 48 also does not produce any reaction that would be measurable by sensor 16. Appropriate low friction and chemically unreactive materials include polytetrafluoroethylene, glass, and ceramic.

Turning back to FIG. 7, fibre optic cable 18 may also be housed within a tube 52 proximate package 36. Tube 52 fits within control line 28 and may terminate at a location 54 distal to package 36. Tube 52 may also protrude into package 36 (see FIG. 8) passing through hole 46 of attachment section 44, thereby protecting fibre optic cable 18. Within protector 50, fibre optic cable 18 passes from tube 52 to sleeve 48.

Tube 52 is held in place by its connection to attachment section 44. In one embodiment, the tube 52 and attachment section 44 connection is by way of a nut 56 and fitting 58 mechanism. As the nut 56 is tightened, the fitting 58 which also surrounds tube 52 locks against the tube 52 and within the profile 60 of the attachment section 44 thereby holding tube 52 in place in relation to attachment section 44.

Protector 50, which may be constructed from stainless steel, is connected to tube 52 by way of a spacer 62. Spacer 62 is connected to tube 52 such as by threading. Protector 50 is then connected to spacer 62. In one embodiment, protector 50 forms an interference fit around spacer 62, which connection holds protector 50 in place in relation to tube 52 and attachment section 44.

Sleeve 48 is fixed in place to protector 50. In one embodiment, sleeve 48 is connected to protector 50 by way of an adhesive 64 that fixes (either by adhesion or by interference fit) the sleeve 48 to the protector 50. Since sleeve 48 is fixed in relation to protector 50 and protector 50 is fixed in relation to attachment section 44, sleeve 48 is therefore fixed in relation to attachment section 44. As shown in FIG. 9, one or more filler elements 100, such as the rods shown in the Figure, may be disposed longitudinally between sleeve 48 and protector 50 to inhibit the bending of sleeve 48, if and when an external force acts thereon. The filler element 100 may be made from stainless steel or another rigid element. The filler element 100 may be attached by the same adhesive 64.

Protector 50 may include a vent hole 66 which provides fluid communication between the interior 68 and exterior 70 of protector 50. In use, fluid 41 may enter the interior 68 of protector 50 through sleeve 48, which sleeve 48 remains open to the exterior of 70 of protector 50. Since sleeve 48 is the primary route by which fluid 41 enters the interior 68 of protector 50 and such sleeve 48 is small in diameter, the flow rate of fluid 41 therethrough is relatively slow which, without vent hole 66, may lead to a pressure differential being created across protector 50. Vent hole 66 helps to equalize the pressure across protector 50 thereby ensuring that sensor 16 obtains an accurate reading.

Control line 28 is typically extended to the surface 12. Since fibre optic cable 18 and sensor 16 are extended through control line 28 and are exposed to high pressure (in the embodiment with bellows 38) or are perhaps even in direct contact with wellbore 10 fluids (in other embodiments), it is important to ensure that the interior of the control line 28 is adequately sealed against such pressure and fluids to prevent their transmission to the surface 12. A seal 68 is provided between fitting 58 and tube 52 that prevents pressure or fluid from passing through hole 46 between attachment section 44 and tube 52. Moreover, another seal 70 is located intermediate tube end location 54 and attachment section 44, which seal 70 seals against the fibre optic cable 18 within tube 52. Thus, any pressure or fluid passing through the interior of tube 52 from package 36 is blocked at seal 70 and prevented from progressing any further towards the surface 12. Seal 70 can comprise a fitting on tube 52 which enables the fibre cable 18 to be glued and thus sealed to the interior of the fitting. Another seal 72, similar to seal 70, may also be added for redundancy and safety.

As discussed in relation to FIG. 6, control line 28 can be configured in a U-shape so that package 36 is “inverted.” This configuration is specially beneficial in inclined or angled wellbores 10. In this embodiment, fluid 41 is preferably a high-density fluid. Thus, if package 26 is inverted, sensors 16 may “float” in the high-density fluid 41 so as to reduce the likelihood that such sensors 16 would contact the sleeve 48. High density fluids can comprise liquid metals including gallium, indium, and alloys thereof.

If control line 28 is configured as shown in FIG. 5, fluid 41 may be a low-density fluid. Thus, sensors 16 may “sink” in the low-density fluid 41 so as to reduce the likelihood that such sensors 16 would contact the sleeve 48. Low-density fluids can comprise oils, gels, or greases, including Fomblin grease, Syltherm 800, and Dow Corning's D10H.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An apparatus for deployment of a sensor, comprising:
a fibre optic sensor deployed in a remote location; and
the fibre optic sensor housed within a sleeve including a low friction material.

2. The apparatus of claim 1, wherein the sleeve is constructed from polytetrafluoroethylene.

3. The apparatus of claim 1, wherein the sleeve is constructed from glass.

4. The apparatus of claim 1, wherein a fluid surrounds the sensor.

5. The apparatus of claim 6, wherein the fluid comprises a high-density fluid.

6. The apparatus of claim 5, wherein the sensor floats in the high-density fluid.

7. The apparatus of claim 4, wherein the fluid comprises a low-density fluid.

8. The apparatus of claim 7, wherein the sensor sinks in the low-density fluid.

9. The apparatus of claim 1, wherein:
a bellows surrounds the sensor;
a fluid is disposed within the bellows;
the sensor is adapted to measure a parameter external to the bellows; and
The fluid and bellows transfer the parameter to the sensor.

10. The apparatus of claim 9, wherein the parameter is pressure and the fluid transfers the pressure to the sensor as the bellows contracts and expands.

11. The apparatus of claim 9, wherein the parameter is temperature and the fluid and the bellows thermally transfer the temperature to the sensor.

12. The apparatus of claim 1, wherein the remote location is within an oil or gas well.

13. The apparatus of claim 12, wherein the sensor is deployed to sense an exterior wellbore parameter.

14. The apparatus of claim 12, wherein the sensor is deployed on a tubing having an interior to sense a parameter in the tubing interior.

15. The apparatus of claim 14, wherein:
the tubing comprises a mandrel with a port;
the sensor is installed in the port; and
the port is in fluid communication with an interior of the mandrel.

16. The apparatus of claim 1, wherein:
the sleeve is deployed within a package;
the fibre optic cable is deployed within a control line; and
the package is attached to the control line.

17. The apparatus of claim 16, wherein the package and the control line are connected so as to prevent pressure or fluids from passing from the sensor up through the control line.

18. The apparatus of claim 16, wherein:
the sleeve is disposed within and is attached to a protector; and
the protector is fixed in relation to the control line.

19. The apparatus of claim 18, wherein the sleeve is glued to the protector.

20. The apparatus of claim 18, wherein:
a fibre optic cable is connected to the sensor and is housed within a tube;
the tube is housed within the control line;
the tube terminates at a location distal to the package; and
the tube protrudes into the package.

21. The apparatus of claim 20, wherein:
the tube extends within the protector; and
the fibre optic cable extends from the tube to the sleeve.

22. The apparatus of claim 21, wherein:
a seal prevents pressure or fluids from passing from the sensor around the exterior of the tube; and
a seal prevents pressure or fluids from passing from the sensor through an interior of the tube.

23. The apparatus of claim 20, wherein the protector is attached to the tube.

24. The apparatus of claim 20, wherein the protector includes a vent hole providing fluid communication between the interior and exterior of the protector.

25. The apparatus of claim 16, wherein the control line is U-shaped.

26. The apparatus of claim 1, further comprising:
a plurality of fibre optic sensors;
the fibre optic sensors deployed in a remote location; and
each fibre optic sensor housed within a sleeve including a low friction material.

27. The apparatus of claim 26, wherein each of the fibre optic sensors is connected to one fibre optic cable.

28. The apparatus of claim 26, wherein each of the fibre optic sensors is connected to a separate fibre optic cable.

29. The apparatus of claim 1, wherein the sleeve is constructed from ceramic.

30. A method for deploying a sensor, comprising:
deploying a fibre optic sensor to a remote location; and
providing a sleeve including a low friction material around the sensor.

31. The method of claim 30, further comprising floating the sensor in a high-density fluid that surrounds the sensor.

32. The method of claim 30, further comprising sinking the sensor in a low-density fluid that surrounds the sensor.

33. The method of claim 30, wherein the deploying step comprises deploying the sensor and cable in an oil or gas well.

34. The method of claim 30, further comprising constructing the sleeve at least partially from polytetrafluoroethylene.

35. The method of claim 30, further comprising constructing the sleeve at least partially from glass.

36. The method of claim 30, further comprising constructing the sleeve at least partially from ceramic.

37. The method of claim 36, further comprising:
surrounding the sensor with a bellows that includes a fluid;
measuring a parameter external to the bellows with the sensor; and
transferring the parameter from an exterior of the bellows to the sensor through the fluid and the bellows.

38. The method of claim 37, wherein the parameter is pressure and the fluid transfers the pressure to the sensor as the bellows contracts and expands.

39. The method of claim 37, wherein the parameter is temperature and the fluid and the bellows thermally transfer the temperature to the sensor.

40. A method for deploying a sensor, comprising:
deploying a fiber optic sensor in a remote location; and
floating the sensor in a high-density fluid that surrounds the sensor.

41. A method for deploying a sensor, comprising:
deploying a fiber optic sensor in a remote location; and
sinking the sensor in a low-density fluid that surrounds the sensor.
